(19) United States
(12) Patent Application Publication
(10) Pub. No.: US 2004/0075632 A1
(43) Pub. Date: Apr. 22, 2004

(54) Liquid crystal display panel and driving method thereof

(75) Inventors: Hsien-Ying Chou, Hsinchu (TW); Chien-Sheng Yang, Taipei (TW)

Correspondence Address: Richard P. Berg, Esq., c/o LADAS & PARRY, Suite 2100, 5670 Wilshire Boulevard, Los Angeles, CA, 90036-5679, US

(73) Assignee: AU Optronics Corp.

(21) Appl. No.: 10/685,845

(22) Filed: Oct. 14, 2003

(30) Foreign Application Priority Data
Oct. 15, 2001 (TW) 91123738

(51) Int. Cl. G09G 3/36

(52) U.S. Cl. 345/96

(57) ABSTRACT

A liquid crystal display (LCD) panel and driving method thereof. Gates of two adjacent control transistors of display units are respectively connected to a first and a second scan electrodes in a row of display units between two adjacent electrodes, i.e., the first and the second scan electrodes. With the LCD panel structure, dot inversion driving is applied to the panel such that video signal polarization arrangement for the panel presents a polarization arrangement spatially similar to line inversion driving. Thus, black matrix area is reduced to increase panel transmittance while reducing crosstalk.

### BACKGROUND OF THE INVENTION

1. Field of the Invention

The invention relates to a liquid crystal display (LCD) panel and driving method thereof, more particularly to an LCD panel applying dot inversion driving to obtain video signal polarization arrangement in the form of line inversion, and method of driving the LCD panel.

2. Description of the Related Art

FIG. 1 is a schematic diagram of an equivalent circuit of a typical thin film transistor liquid crystal display (TFT-LCD). As shown in FIG. 1, crossed data electrodes D1, D2, D3, . . . , Dy and scan electrodes G1, G2, . . . , Gx form an LCD panel 1. Each crossed data and scan electrode controls a display unit. For example, crossed data electrode D1 and scan electrode G1 control display unit 100. Display unit 100 or any display unit has an equivalent circuit including a thin film transistor 10 for control, a storage capacitor Cs and a liquid crystal capacitor Clc formed by pixel and common electrodes. Gate and drain of transistor 10 are respectively connected to scan electrode G1 and data electrode D1. Thus, video signal on data electrode D1 is written in display unit 100 through the control of scan signal on scan electrode G1 to transistor 10 on/off. Scan driver 3 sequentially outputs scan signals on every scan electrode G1, G2, . . . , or Gx, according to scan control signals, to turn on all transistors in a row of display units and turn off all transistors in other rows at the same time. When the transistors are completely turned on, data driver 2 sends grey levels, with respect to image data to be displayed to the y display units in the on row through data electrodes D1, D2, . . . , Dy. When x scan lines are completely scanned by scan driver 3 at a time, it displays an image frame on the panel. Accordingly, all scan lines are repeatedly scanned to send video signals for display on the panel frame by frame, thus completing image display.

Video signals on data electrodes D1, D2, . . . , Dy are generally divided into positive video signals and negative video signals with respect to common electrode voltage VCOM. Additionally, as a driving method for a single display unit in TFT-LCD, positive frames and negative frames respectively receive polarization video signals opposite to each other, such that a liquid crystal molecule will not be biased by only the same polarizing electric field which reduces product lifetime.

According to different polarization video signals, common types for a frame arrangement on display units are line inversion and dot inversion.

FIG. 2A is a schematic diagram of video signal polarizations received by display units in the form of line inversion. In FIG. 2A, the left side is an odd frame having video signal polarizations received by display units in a panel area defined by data electrodes Dn−1, Dn, Dn+1 and scan electrodes Gm−1, Gm, Gm+1 in an odd frame, and the right side is an even frame having video signals polarizations received by display units in a panel area defined by data electrodes Dn−1, Dn, Dn+1 and scan electrodes Gm−1, Gm, Gm+1. As shown in FIG. 2A, display units in the same row such as Gm receive the same polarization video signals while display units on two adjacent rows such as Gm−1 and Gm+1 receive polarization video signals opposite to the row Gm.

FIG. 2B is a schematic diagram of video signal polarizations received by display units in the form of dot inversion. In FIG. 2A, every display unit has a polarization opposite to the surrounding display units. That is, video signals are arranged interlaced with positive and negative polarizations.

FIG. 3 is a schematic diagram of a part of a typical LCD panel circuit. In FIG. 3, the circuit includes data electrodes Dn−1, Dn, Dn+1, scan electrodes Gm−1, Gm, Gm+1, and corresponding display units. When scan electrode Gm−1 receives scan signal, TFTs connected to electrode Gm−1 are turned on and video signals on data electrodes Dn−1, Dn, Dn+1 are coupled to relative pixel electrodes of display units, respectively. Next, when scan electrode Gm receives scan signal, transistors TFT1, TFT2, TFT3 connected to electrode Gm are turned on and video signals on data electrodes Dn−1, Dn, Dn+1 are coupled to relative pixel electrodes P1, P2, P3 of display units, respectively.

When video signal polarizations are arranged in dot inversion, electric field distribution between adjacent pixels as is shown in FIG. 4A. When video signal polarizations are arranged in line inversion, electric field distribution between adjacent pixels as is shown in FIG. 4B. In FIGS. 4A and 4B, numbers 40, 42 indicate front and rear substrates of an LCD panel, symbol Bx indicates black matrix, symbol E_Vcom indicates common electrode, Dn, Dn+1 indicate data electrodes, and P1˜P3 indicate pixel electrodes. It is noted that arrows between substrates 40 and 42 indicate electric field distribution.

As shown in FIG. 4A, during dot inversion driving, edges between adjacent pixels (such as an interface of P1 and P2 and another interface of P2 and P3) present deformed electrical lines. These deformed lines cause light leakage on a display frame. Therefore, black matrix covers leak areas for a higher display quality. However, the used areas for black matrix will decrease transmittance because area available for pixels is reduced.

As shown in FIG. 4B, during line inversion driving, every two adjacent pixels in the same row have the same polarization (such as “+”). Therefore, edges between adjacent pixels (such as an interface of P1 and P2 and another interface of P2 and P3) present less deformed electric field compared with FIG. 4A. The required area of black matrix in this design is lower and relatively the available area for pixels is increased. Hence, the panel transmittance is increased. However, during line inversion driving, the coupling between data bus and pixel and common electrodes easily causes crosstalk on a display frame.

### SUMMARY OF THE INVENTION

It is an object of the present invention to provide an LCD panel and driving method thereof, which uses dot inversion driving to present a video signal polarization arrangement spatially similar to line inversion driving on the panel. Thus, the required area of black matrix is reduced, thus increasing transmittance of the panel and reducing crosstalk.

The present invention provides an LCD panel, including a plurality of scan electrodes, a plurality of data electrodes, and a plurality of display units. Each display unit corresponds to crossed scan and data electrodes and has a pixel electrode and a control transistor. Gates of control transistors of two adjacent display units in a row between first and second adjacent scan electrodes are respectively connected to the first scan electrode and the second scan electrode.

Gates of control transistors of two adjacent display units in a column between two adjacent data electrodes are not connected to the same scan electrode.

The LCD panel also includes a common electrode. The common electrode is connected to each pixel electrode to form a liquid crystal capacitor for each display unit.

According to the object of the invention, a driving method for LCD panel includes changing display unit arrangement in an LCD panel such that gates of control transistors of two adjacent display units in the same row are respectively connected to a first scan electrode and a second scan electrode, thus forming a desired LCD panel structure, and performing dot inversion driving to the display units. Therefore, when dot inversion driving is completed for a frame on the LCD panel, all display units in the same row of the frame have the same video signal polarization and display units in two adjacent rows of the frame present polarization opposite to each other.

### DESCRIPTION OF THE DRAWINGS

The present invention will be described by way of exemplary embodiments, but not limitations, illustrated in the accompanying drawings in which like references denote similar elements, and in which:

FIG. 1 is a schematic diagram of an equivalent circuit of a typical thin film transistor liquid crystal display (TFT-LCD);

FIG. 2A is a schematic diagram of video signal polarizations received by display units in the form of line inversion;

FIG. 2B is a schematic diagram of video signal polarizations received by display units in the form of dot inversion;

FIG. 3 is a schematic diagram of a part of a typical LCD panel circuit;

FIG. 4A is a schematic diagram of electric field distribution between adjacent pixels when video signal polarizations are arranged in dot inversion;

FIG. 4B is a schematic diagram of electric field distribution between adjacent pixels when video signal polarizations are arranged in line inversion;

FIG. 5 is a schematic diagram of a liquid crystal display (LCD) panel according to the invention;

FIG. 6 is a schematic diagram of a partial frame of FIG. 5 according to the invention; and

FIGS. 7A˜7D are schematic diagrams of video signal polarization arrangement for every pixel electrode in a frame when scan signals are sequentially sent to scan electrodes Gx−1˜Gx+1 in dot inversion.

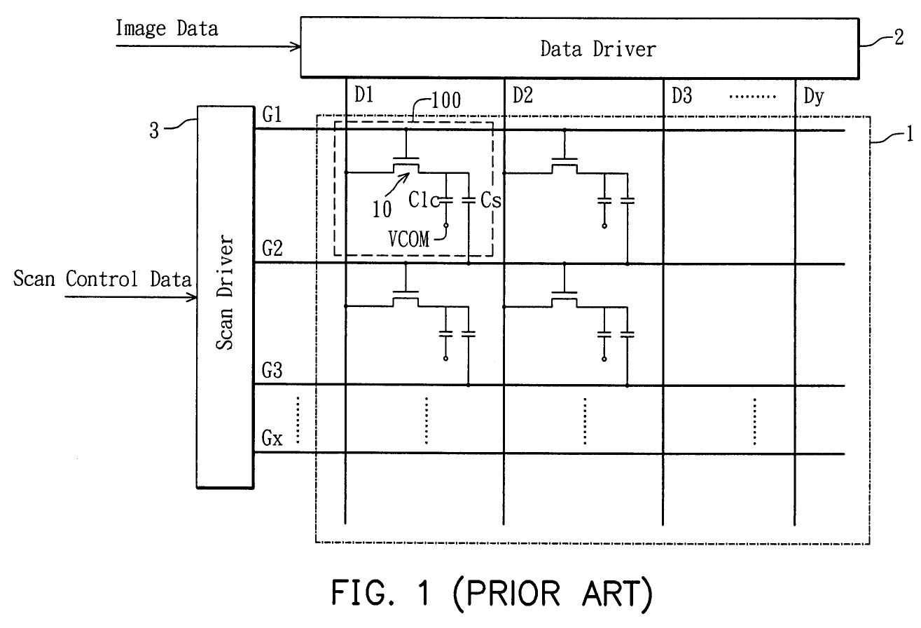

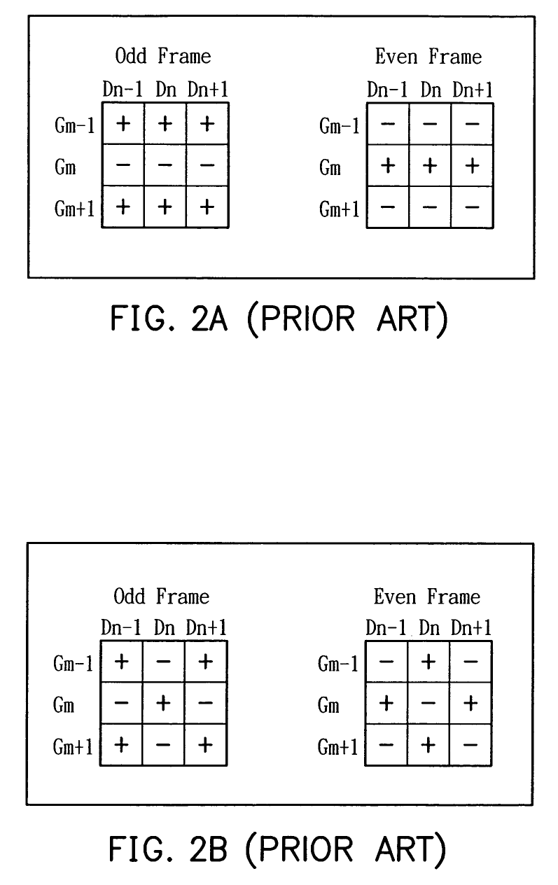

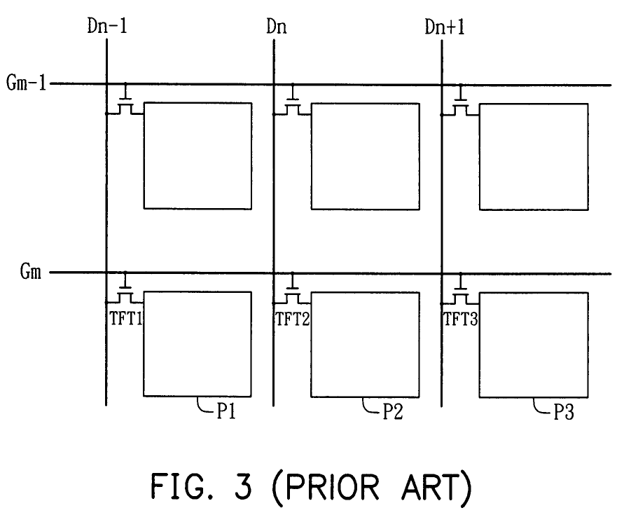

### DETAILED DESCRIPTION OF THE INVENTION

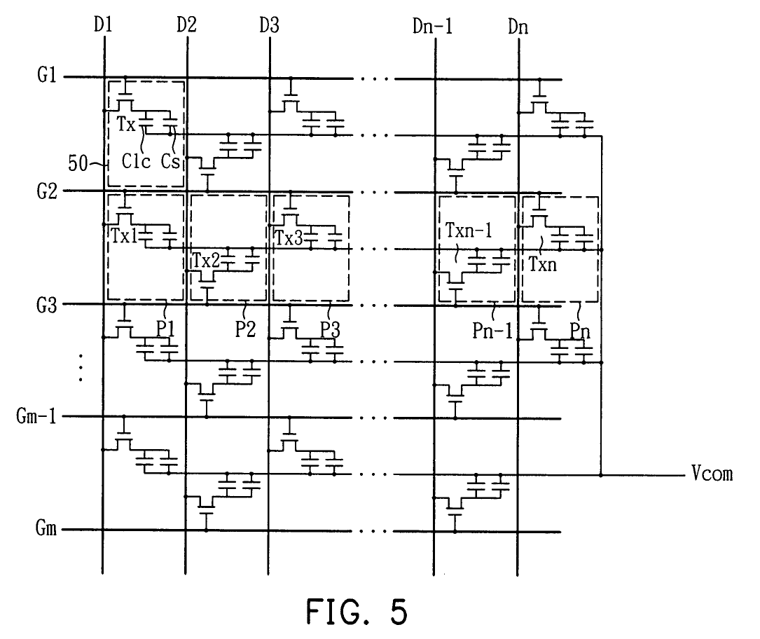

FIG. 5 is a schematic diagram of a liquid crystal display (LCD) panel according to the invention.

The inventive driving method for LCD panel majorly changes the coupling arrangement of display units for the LCD panel, such that gates of control transistors of two adjacent display units in the same row are connected to a first scan electrode and a second scan electrode, respectively, and thus obtain the LCD panel structure shown in FIG. 5. Next, dot inversion driving is used on the display units of the panel. As such, when dot inversion driving is completed for a frame on the LCD panel, all display units in the same row of the frame have the same video signal polarization and display units in two adjacent rows of the frame present polarization opposite to each other.

Referring to FIG. 5 now, the LCD panel includes a plurality of scan electrodes (G1, G2, . . . , Gm−1, Gm), a plurality of data electrodes (D1, D2, D3, . . . , Dn−1, Dn), a plurality of display units, and a common electrode Vcom. Each display unit 50 corresponds to a crossed scan and data electrode and has a pixel electrode Px and a control transistor Tx. Gates of control transistors of two adjacent display units in a row between first and second adjacent scan electrodes are respectively connected to the first scan electrode and the second scan electrode. The common electrode is connected to each pixel electrode 50 to form a relative liquid crystal capacitor Clc and storage capacitor Cs of each display unit 50.

The feature of the inventive panel structure is that gates of control transistors of two adjacent display units in a row between first and second adjacent scan electrodes are respectively connected to the first scan electrode and the second scan electrode, and gates of control transistors of two adjacent display units in a column between two adjacent data electrodes are not connected to the same scan electrode. For example, gate G2 of control transistor Tx1 of display unit P1 is connected to scan electrode G2, and gate G3 of control transistor Tx2 of display unit P2 is connected to scan electrode G3.

Referring to FIG. 5 again, an example is given by scan electrodes G2, G3, where a row of display units P1, P2, P3, . . . , Pn−1, Pn are arranged between G2 and G3. Gate of control transistor Tx1 of display unit P1 is connected to scan electrode G1. Gate of control transistor Tx2 of display unit P2 is connected to scan electrode G3. Gate of control transistor Tx3 of display unit P3 is connected to scan electrode G2. Gate of control transistor Txn−1 of display unit Pn−1 is connected to scan electrode G3. Gate of control transistor Txn of display unit Pn is connected to scan electrode G2. In such an arrangement, gates of control transistors of any two adjacent display units in the display units P1˜Pn are respectively connected to scan electrodes G2 (first scan electrode) and G3 (second electrode).

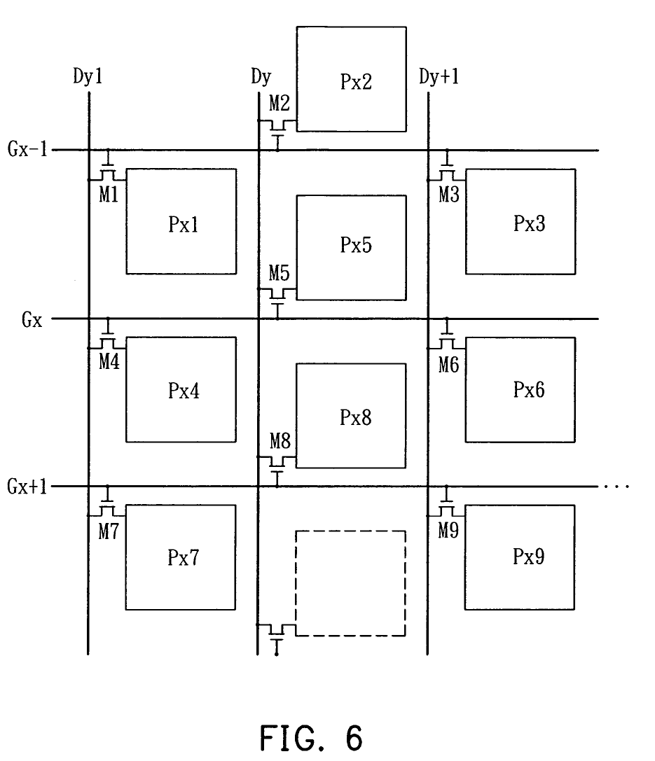

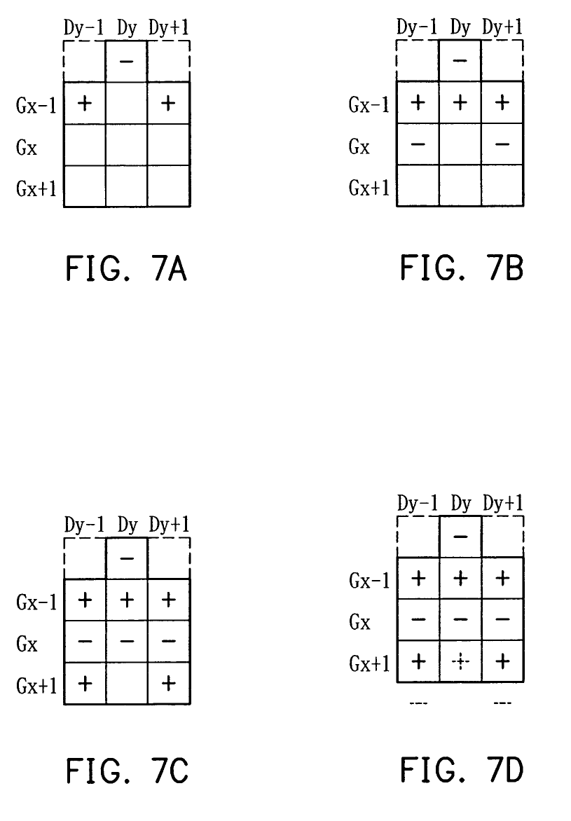

FIG. 6 is a schematic diagram of a partial frame of FIG. 5 according to the invention. The partial frame includes data electrodes Dy−1, Dy, Dy+1, scan electrodes Gx−1, Gx, Gx+1 and control transistors M1˜M9 and pixel electrodes Px1˜Px9 corresponding to display units. FIGS. 7A-7D are schematic diagrams of video signal polarization arrangement for every pixel electrode in a frame when scan signals are sequentially sent to scan electrodes Gx−1˜Gx+1 in dot inversion. The following description using dot inversion obtaining line inversion arrangement on a frame of the inventive LCD panel is given by reference to FIGS. 6, 7A-7D.

At the beginning, the panel is driven by dot inversion.

When scan signal is sent to scan electrode Gx−1, TFTs M1˜M3 are turned on. Data electrodes Dy−1, Dy, Dy+1 then output video signals (whose polarizations are “−”, “+”, respectively) respectively coupled to pixel electrodes Px1˜Px3. The resulting video signal polarization arrangement on the frame is shown in FIG. 7A.

Next, when scan signal is sent to scan electrode Gx, TFTs M4˜M6 are turned on. Data electrodes Dy−1, Dy, Dy+1 then output video signals (whose polarizations are “−”, “+”, “−”, respectively) respectively coupled to pixel electrodes Px4˜Px6. The resulting video signal polarization arrangement on the frame is shown in FIG. 7B.

Next, when scan signal is sent to scan electrode Gx+1, TFTs M7˜M9 are turned on. Data electrodes Dy−1, Dy, Dy+1 then output video signals (whose polarizations are “+”, “−”, “+” respectively) respectively coupled to pixel electrodes Px7˜Px9. The resulting video signal polarization arrangement on the frame is shown in FIG. 7C.

Next, when scan signal is sequentially sent to scan electrode Gx+2 (not shown), TFTs with respect to Gx+2 are turned on. Data electrodes Dy−1, Dy, Dy+1 then output video signals (whose polarizations are “−”, “+”, “−”, respectively) respectively coupled to corresponding pixel electrodes. The resulting video signal polarization arrangement on the frame is shown in FIG. 7D, where symbols “+” and “−” in dotted line indicate currently written video signal polarizations.

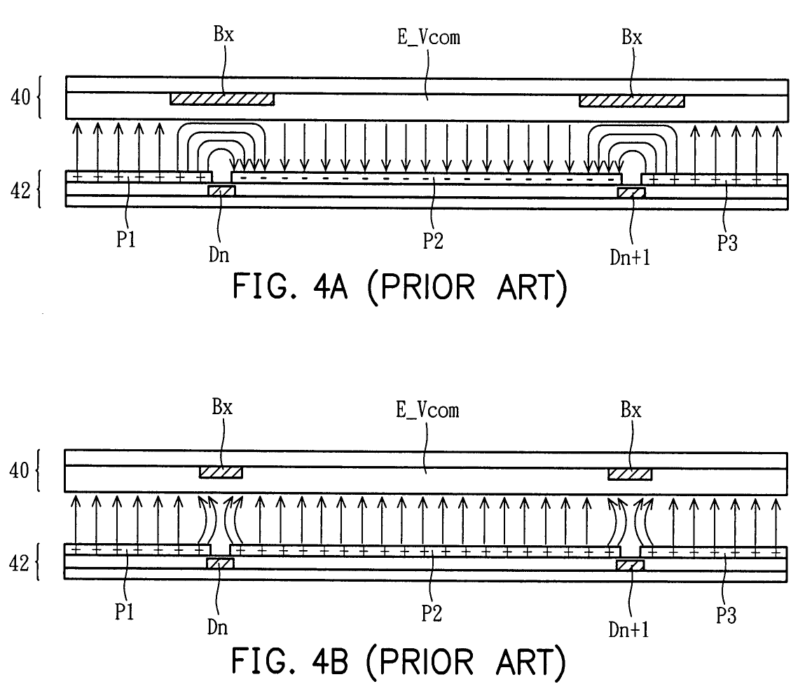

As shown in FIG. 7D, the resulting video signal polarization arrangement on pixel electrodes Px1˜Px9 in the frame presents a line inversion polarization arrangement. Therefore, as shown in FIG. 4B, edges between two adjacent pixels have less electric field deformation than in FIG. 4A. Accordingly, black matrix Bx area is reduced by design and the relative area available for pixels is increased, thereby increasing transmittance of the panel.

In addition, due to the use of dot inversion driving, positive polarization and negative polarization on data bus are respectively halved, thus the coupling between data bus and a pixel electrode Px and common electrode Vcom does not generate crosstalk from positive and negative polarization cancellation.

Thus, the invention provides a novel LCD panel structure, applying dot inversion driving to obtain a polarization arrangement spatially similar to line inversion driving. Thus, black matrix area is reduced such that the panel transmittance is increased while crosstalk is reduced.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A liquid crystal display (LCD) panel, using dot inversion driving to present a video signal polarization arrangement spatially similar to line inversion driving on the panel, comprising:
a plurality of scan electrodes;
a plurality of data electrodes; and
a plurality of display units, each corresponding to a crossed scan electrode and data electrode and having a pixel electrode and a control transistor,
wherein gates of control transistors of two adjacent display units in a row between a first and second adjacent scan electrode are respectively connected to the first scan electrode and the second scan electrode, and
when dot inversion driving is completed for a frame on the LCD panel, display units in the same row of the frame have the same video signal polarization and display units in two adjacent rows of the frame present polarizations opposite to each other.

2. The LCD panel according to claim 1, wherein gates of control transistors of two adjacent display units in a column between two adjacent data electrodes are not connected to the same scan electrode.

3. The LCD panel according to claim 1, further comprising a common electrode, connected to each pixel electrode to form a liquid crystal capacitor for each display unit.

4. A driving method for an LCD panel including a plurality of scan electrodes, a plurality of data electrodes, and a plurality of display units, each corresponding to a crossed scan electrode and data electrode and having a pixel electrode and a control transistor, the driving method comprising the steps:
changing display unit arrangement on the LCD panel such that gates of control transistors of two adjacent display units in the same row are respectively connected to a first scan electrode and a second scan electrode, thus forming the LCD panel structure; and
performing dot inversion driving to the display units,
wherein when the dot inversion driving is completed for a frame on the LCD panel, all display units in the same row of the frame have the same video signal polarization and display units in two adjacent rows of the frame present polarization opposite to each other.

5. The driving method according to claim 4, wherein gates of control transistors of two adjacent display units in a column between two adjacent data electrodes are not connected to the same scan electrode.
